(19) United States
(12) Patent Application Publication
(10) Pub. No.: US 2018/0311950 A1
(43) Pub. Date: Nov. 1, 2018

(54) Internal Ink Manifold and Ink Changing Method

(71) Applicant: Goss International Americas, Inc., Durham, NC (US)

(72) Inventors: Daniel Paul Gagne, South Berwick, ME (US); James Vrotacoe, Barrington, NH (US); Ethan Hunter Thibaudeau, Dover, NH (US)

(21) Appl. No.: 15/963,869

(22) Filed: Apr. 26, 2018

Related U.S. Application Data
(60) Provisional application No. 62/491,464, filed on Apr. 28, 2017.

(51) Int. Cl. B41F 31/20; B41F 35/00; B41F 31/02

(52) U.S. Cl. CPC B41F 31/20; B41P 2235/21; B41F 31/02; B41F 35/00

(57) ABSTRACT

An inking system for a printing press is provided, including a structural member; an internal ink manifold housed in the structural member; and a shuttle inside the internal ink manifold and movable along a length of the internal ink manifold.

### CROSS REFERENCE TO RELATED APPLICATION

Priority is hereby claimed to U.S. Provisional Application No. 62/491,464 filed Apr. 28, 2017, and hereby incorporated by reference herein.

### BACKGROUND

The present invention relates generally to inking devices and ink metering systems for printing presses.

As currently known in the art, ink metering systems utilize ink manifolds external to the support structure of the system to distribute the ink supply. When there is an open ink fountain, a manifold with a plurality of orifices resides over an ink trough separate from the support structure. A valve between the main ink supply and the manifold is open or closed to control to maintain a desired level of ink in the trough. When there is a closed ink metering device, ink is distributed from a separate ink manifold to the metering device or groups of metering devices (packs) via a series of fittings and hoses. The metering packs are then mounted to the structural member for distribution of ink to the print unit.

Cleaning the separate manifold is difficult and time consuming. To compensate for this, color specific manifold and distribution pumping is often utilized. A manifold is dedicated to one color. In open ink fountains ink colors may be changed, but the process is messy, time consuming and manual in nature. In addition, hand cleaning an internal manifold wastes ink and is labor intensive.

### BRIEF SUMMARY OF THE INVENTION

Separate manifolds are added to components of ink delivery systems which increase the cost and complexity of the system. In closed systems, ink in the manifold and distribution hoses is pressurized. Hoses expand under pressure and store energy (expanded elastomer) and ink (increased volume in expanded hoses). During idle periods, a valve between the manifold and main ink supply is closed trapping the pressurized ink. The stored energy in the hoses is relieved via ink leakage through the metering device. This results in startup issues, for example, when there is too much ink in the system, or increased maintenance, for example, ink on the floor. In addition, the assembly of the manifold, fittings and hoses is difficult to clean a change in ink color within a unit is desired.

Rigid piping has been considered to address the potential for leakage. This solution is not practical due to increased complexity and cost. A rigid ink distribution system would increase the difficulty of cleaning for color change.

### BRIEF DESCRIPTION OF THE DRAWINGS

A preferred embodiment of the present invention will be elucidated with reference to the drawings, in which:

FIGS. 1 to 4 show an inking system with an internal manifold and shuttle according to the present invention.

### DETAILED DESCRIPTION OF A PREFERRED EMBODIMENT

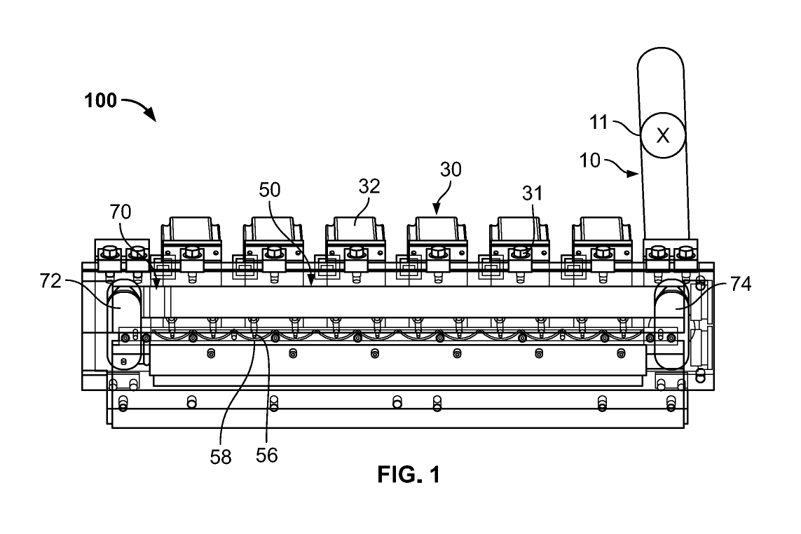

FIGS. 1 to 4 show an internal manifold 60 with a shuttle 70 for an ink metering device 30 in accordance with the present invention. Inking system 100 includes an ink supply 10, a structural member 20, and removable ink metering devices 30 connected to structural member 20 via clamps 31. Structural member 20 includes a distribution rail 50 and internal manifold 60. The shuttle 70 is located inside internal manifold 60.

An internal manifold 60 is incorporated into distribution rail 50 of main structural member 20 which eliminates components and complexity of the inking system. Ink manifold 60 can be formed by extrusion, machined, a machined bore or a cast cavity, for example, internal to rail 50. Internal manifold includes an upper manifold chamber 62 and a lower manifold chamber 64 to improve flow while minimizing size.

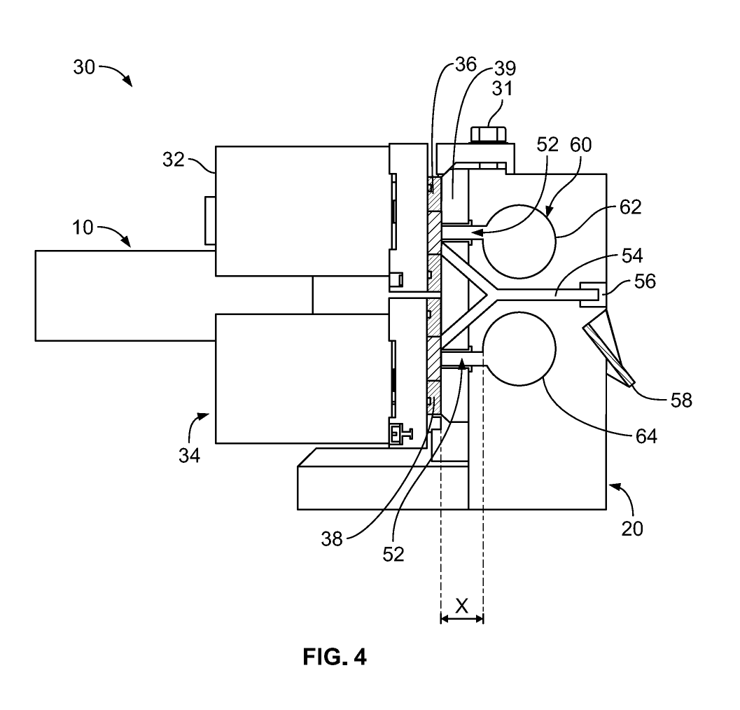

Each removable ink metering device 30 includes two motors 32, 34 two pumps 36, 38 and a single wedge mounting plate 39 as shown in FIG. 4. Ports 52 connect upper manifold chamber 62 to pump 36 and lower manifold chamber 64 to pump 38, respectively.

Ink supply 10, which may be the main ink supply of inking system 100, is connected to internal manifold 60. A control valve 11 may be provided. Ink is distributed from supply 10 to each of the ink metering devices 30 via internal manifold 60.

During operation, ink enters inking system 100 via ink supply 10 and fills manifolds 62, 64 across a length of rail 50 under pressure from ink supply 10. The ink supply pressure is maintained at a sufficient level for the ink to flow from the ink supply 10 to and through the inter manifold chambers 62, 64. The ink moves from manifolds 62, 64 through ports 52. Motors 32, 34 and pumps 36, 38 pump ink via channels 54 to orifices 56. Ink exits structural member 20 through orifices 56 and is distributed to printing units therefrom.

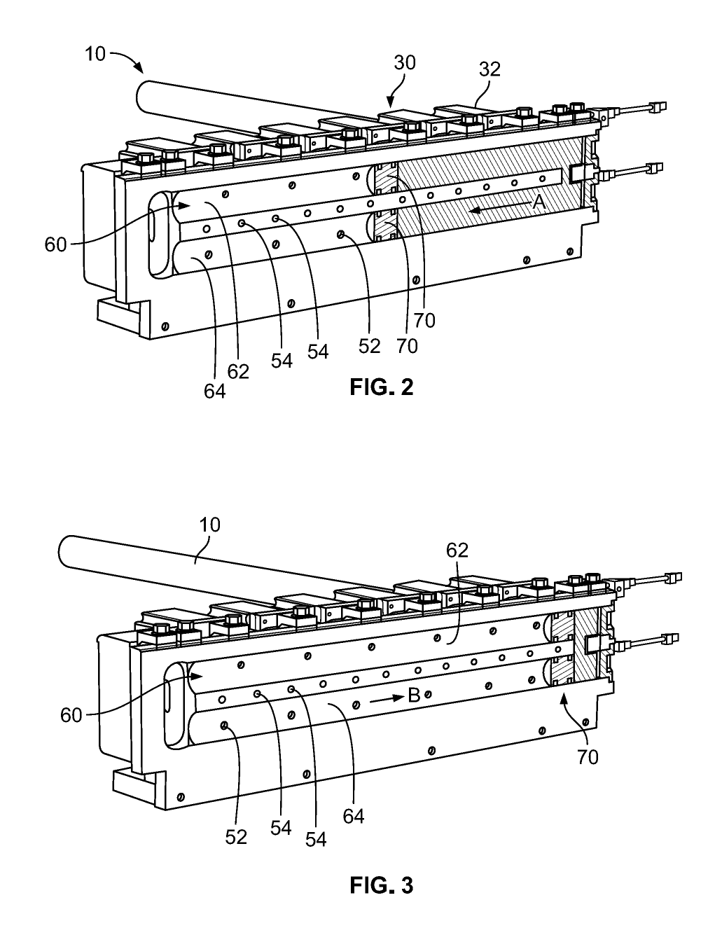

As shown in FIGS. 1 to 3, internal manifold 60 includes a shuttle 70 in accordance with the present invention. A shuttle 70 is added inside each internal manifold chamber 62, 64. The main ink supply 10 motivates shuttle 70 to move along a length of manifold 60 in direction A (FIG. 2) until shuttle 70 reaches a stop 72 at an end of internal manifold 60 opposite the main ink supply 10. For example, in FIG. 1, the ink supply is located on a gear side of a printing press unit and a stop 72 is located on the work side of the printing unit. A second stop 74 is provided on the gear side of the printing unit. Shuttle 70 resides at stop 72 until a color or ink change is desired.

When a color or ink change is desired, shuttle 70 is motivated in direction B toward main ink supply 10 by adding pressure to the back side of the shuttle 70. As shuttle 70 moves in direction B, shuttle 70 pushes ink back to main ink supply 10. FIG. 3. A pressure tight interface between shuttle 70 and internal manifold chambers 62, 64 of internal manifold 60 efficiently wipes the ink leaving only a minimal film of ink adhered to an interior of the manifold chamber surfaces. An alternate ink supply is then free to flow through the manifold 60. The remaining ink film is largely undisturbed as the alternate ink passes though the manifold 60 due to a viscous boundary layer. Therefore, the hue shift between ink colors is minimized to a less than noticeable level. A third ink color can then be swapped with the main ink supply, if desired.

The shuttle 70 advantageously provides the ability to cleanly and quickly remove ink from internal manifold 60 so the ink can be removed and or the ink supply may be changed.

Inking system 100 is simplified by the use of an internal manifold 60 and with the elimination of an external manifold as known in the art. Cleaning is improved with internal manifold 60 because fittings and hoses have been eliminated. The elimination of hoses eliminates a source of ink leakage during idle periods of the inking system. In addition, the rigid nature of the rail 50 eliminates the source of leakage from expanding hoses.

Another advantage of internal manifold 60 in inking system 100, is that a distance X from ink supply of upper and lower manifolds 62, 64 to pumps 36, 38, respectively, is reduced. Distance X is critical and is desired to be as short as possible in order to minimize the amount of ink that needs to be flushed out during a color change and to decrease restriction during periods of high demand and high flow. Internal manifold 60 places the ink as close to pump 36, 38 as physically possible.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An inking system for a printing press comprising:
a structural member;
an internal ink manifold housed in the structural member; and
a shuttle inside the internal ink manifold and movable along a length of the internal ink manifold.

2. The inking system as recited in claim 1 wherein the shuttle has a pressure tight interface with an interior of the internal ink manifold.

3. The inking system as recited in claim 1 wherein the shuttle is coaxial with the internal ink manifold.

4. The inking system as recited in claim 1 further comprising an ink supply that can be connected to an end of the internal ink manifold.

5. The inking system as recited in claim 4 wherein a flow of ink from the ink supply moves the shuttle along the length of the internal manifold.

6. The inking system as recited in claim 1 further comprising a stop at a further end of the internal ink manifold.

7. The inking system as recited in claim 4 further comprising an alternate ink supply that can be connected to the end of the internal ink manifold.

8. A printing press comprising:
at least one printing unit; and
an inking system according to claim 1 for providing ink to the at least one printing unit.

9. A method of changing ink color in an inking system comprising the steps of:
providing an internal ink manifold with a shuttle housed therein;
supplying ink of a first color to the internal ink manifold via an ink supply on a first end of the internal ink manifold;
moving the shuttle, via pressure from the ink on a first side of the shuttle, along a length of the internal ink manifold until the shuttle reaches a stop at a second end of the internal ink manifold;
moving the shuttle, via air pressure on a second side of the shuttle, along the length of the internal ink manifold to the first end of the internal ink manifold;
supplying a second ink of a second color to the internal ink manifold via an alternate ink supply on a first end of the internal ink manifold; and
moving the shuttle, via pressure from the second ink on a first side of the shuttle, along a length of the internal ink manifold until the shuttle reaches a stop at a second end of the internal ink manifold.
